(19) United States
(12) Patent Application Publication
(10) Pub. No.: US 2023/0036077 A1
(43) Pub. Date: Feb. 2, 2023

(54) SILICON ANODE BASED LITHIUM-ION BATTERY

(71) Applicant: NOHMS Technologies, Inc., Rochester, NY (US)

(72) Inventors: Surya S. Moganty, Henrietta, NY (US); Rutvik Vaidya, Rochester, NY (US); Xiaojing Zhu, Rochester, NY (US); Kevin Brown, Rochester, NY (US)

(21) Appl. No.: 17/870,577

(22) Filed: Jul. 21, 2022

Related U.S. Application Data
(60) Provisional application No. 63/224,217, filed on Jul. 21, 2021.

(51) Int. Cl. H01M 10/0568; H01M 10/0525; H01M 10/0567; H01M 10/0569; H01M 4/04; H01M 4/66; H01M 4/62; H01M 4/38; H01M 4/48

(52) U.S. Cl. CPC H01M 10/0568; H01M 10/0525; H01M 10/0567; H01M 10/0569; H01M 4/0404; H01M 4/0471; H01M 4/661; H01M 4/625; H01M 4/622; H01M 4/386; H01M 4/483; H01M 2004/021

(57) ABSTRACT

Silicon-polymer composite anodes; a method for producing the anodes; and dual salt electrolytes to improve the conductivity, specific capacity, rate capability, and stability of the anodes; suitable for use in electrochemical energy storage devices are disclosed.

This application claims the benefit of the filing date of U.S. Provisional Patent Application No. 63/224,217, filed Jul. 21, 2021, which is hereby incorporated by reference in its entirety.

### FIELD

The present disclosure relates to silicon-polymer composite anodes; a method for producing the anodes; and dual salt electrolytes to improve the conductivity, specific capacity, rate capability, and stability of the anodes; suitable for use in electrochemical energy storage devices and electrochemical energy storage devices including the anodes and electrolytes.

### BACKGROUND

Lithium Ion (Li-ion) batteries are heavily used in consumer electronics, electric vehicles (EVs), as well as energy storage systems (ESS) and smart grids. The energy density of the battery is dependent on the anode and cathode materials used and optimizing processing and manufacturing have allowed for a 4-5% improvement in the energy density each year, but these increments are not significant. To reach energy density targets of next-generation energy technologies will need advancements in electrode materials, and there is an urgent need to incorporate high energy-density active materials. While a lot of research has focused on developing high energy cathodes, anode materials research has been limited.

Recently, silicon (Si) has emerged as one of the most attractive high energy anode material for Li-ion batteries. Silicon's low working voltage and high theoretical specific capacity of 3579 mAh/g is nearly ten times that of conventional graphite is a major reason for this interest. Despite this significant advantage, silicon anodes face several challenges associated with severe volume expansion and the resultant particle breakdown. While graphite electrodes expand 10-15% during lithium intercalation, Si electrodes expand ˜300%, causing structural degradation and instability of the solid-electrolyte-interphase (SEI) layer. This causes material pulverization and electrode delamination, resulting in loss of capacity with cycling. It is important to have a conductive polymer material as binder coated over the active material silicon to mechanically contain the expansion, contraction, and fragmentation of silicon particles. Similarly, an electrochemically robust SEI layer prevents side reactions that cause capacity fade.

While silicon particle degradation can be mitigated by using smaller than 150 nm active material particles or using other nanostructures, cells using such anode designs are limited by low loadings (less than 15% by mass) of nano silicon materials. Additionally, these anode designs lack sufficiently high coulombic efficiencies due to constant breakdown of SEI layer during expansion and contraction of silicon.

### SUMMARY

In accordance with an aspect of the present disclosure, there is provided an anode for an electrochemical energy storage device including silicon particles, and a polymer; a method for producing the silicon-polymer composite anode; and an electrochemical energy storage device using a dual-salt electrolyte.

In accordance with another aspect of the present disclosure, there is provided an anode for electrochemical energy storage device including a plurality of silicon active materials with particle sizes from 1 nm to 100 μm. Other active materials can include but are not limited to silicon composite materials, graphite, hard-carbon, tin, and germanium particles.

In accordance with another aspect of the present disclosure, there is provided an anode for electrochemical energy storage device including a polymer material, wherein at least one polymer material is PAN.

In accordance with another aspect of the present disclosure, PAN can be cyclized using heat treatment at temperatures of from 200 to 600° C. and convert to a ladder compound by crosslinking polymer chains, where the cyclization changes the nitrile bond (CN) to a double bond (C═N). Polymer binder forms elastic but robust films to allow for controlled fragmentation/pulverization of silicon particles within the binder matrix. The resultant anode material can overcome expansion and conductivity challenges of silicon-based anodes, such as by providing binders that can prevent expansion of silicon particles and conductive additives to provide a path for Li-ion mobility. The polymer is about from 10 to 40 wt. % of the anode composite material.

Described herein are various embodiments of silicon-polymer composite anodes and methods of making the same. The method of making the composite anode includes the steps of mixing together silicon, polymer, and solvent; coating the mixture onto a copper current collector to form a coated copper current collector; and subjecting the coated copper current collector to a temperature treatment. In accordance with one aspect of the present disclosure, the temperature treatment may include heating the coated copper current collector in an inert atmosphere in the temperature range of from 200 to 600° C.

In accordance with another aspect of the present disclosure, an electrochemical energy storage device includes an anode, a cathode, and an electrolyte.

In accordance with another aspect of the present disclosure, there is provided a dual-salt electrolyte, wherein the Li⁺ ion salts are lithium hexafluorophosphate (LiPF₆) and lithium bis(fluorosulfonyl)imide (LiF SI).

In accordance with another aspect of the present disclosure, there is provided a dual-salt electrolyte, wherein the electrolyte includes an aprotic organic solvent system, and at least one additive.

In accordance with another aspect of the present disclosure, there is provided a dual-salt electrolyte, wherein the electrolyte includes an aprotic organic solvent system, and at least one additive; wherein the aprotic organic solvent includes of open-chain or cyclic carbonate, wherein at least one solvent is fluoroethylene carbonate (FEC), carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof.

In accordance with another aspect of the present disclosure, there is provided a dual-salt electrolyte, wherein the electrolyte includes an aprotic organic solvent system, and at least one additive; wherein the additive contains a compound containing at least one unsaturated carbon-carbon bond, carboxylic acid anhydrides, sulfur-containing compounds, phosphorus-containing compounds, boron-containing compounds, silicon-containing compounds, nitrogen-containing compounds, or mixtures thereof.

These and other aspects of the present disclosure will become apparent upon a review of the following detailed description and the claims appended thereto.

### BRIEF DESCRIPTION OF THE DRAWINGS

FIG. 1 shows the FT-IR spectra of Example A electrodes before and after heat treatment in argon gas inert atmosphere at 330° C.;

FIG. 2 is a bar graph showing the Charge Rate Capability for CE and EE electrolytes in the fuel cells of Example D;

FIG. 3 shows the Discharge Rate Capability for CE and EE electrolytes in the fuel cells of Example D;

FIG. 4 is a bar graph of 1^{st} and 2^{nd} cycle efficiency of electrolytes IL1 and Carb1 for the fuel cell of Example F;

FIG. 5 is a bar graph of 1^{st} and 2^{nd} cycle efficiency of electrolytes IL2 and Carb2 for the fuel cell of Example F; and

FIG. 6 is a graph showing a comparison of discharge cycling capacity.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

Herein, silicon-polymer composite anodes are disclosed for silicon anode-based Li-ion batteries, with a dual salt electrolyte. The polymer, primarily polyacrylonitrile (PAN) forms a mechanically stable but elastic film around the silicon active material particles, to allow for self-contained fragmentation. Additionally, dual salt electrolyte with fluorinated solvents and ionic liquid additives forms a robust SEI to prevent anode degradation due to contact with electrolyte and the resultant side reactions.

The disclosed technology relates generally to an electrochemical energy storage device anode. Particularly, the disclosure is directed towards silicon-polymer composite anodes; a dual-salt electrolyte and a Li-ion battery containing the anode and electrolyte.

The present disclosure describes a Li-ion battery anode that can overcome the expansion and conductivity challenges of silicon anodes. The polymer component of the composite anode, more specifically PAN serves as the binder for the silicon anode-based Li-ion battery. PAN is used as a polymer binder to form elastic but robust films to allow for controlled fragmentation/pulverization of silicon particles within the binder matrix. Upon heat treatment, PAN is cyclized where the nitrile bond (CN) gets converted to a double bond (C═N) due to crosslinking of PAN molecules. This treatment yields ladder polymer chains of PAN fiber that are elastic but mechanically robust, thus allowing for controlled fragmentation of silicon particles. Additionally, PAN matrix also provides a path for Li-ion mobility thus enhancing the conductivity of the composite anode.

In an embodiment, there is provided an anode for electrochemical energy storage device including silicon particles, a polymer; and a method for producing the silicon-polymer composite anode; wherein the silicon particles of the silicon-polymer composite anode are suitably and sufficiently coated with a binder material.

Any suitable Si-composite material can be used for the silicon particles included in the anode material described herein. In some embodiments, the silicon particles Si-composite particles include Si-carbon composite materials, such as carbon coated Si particles. In some embodiments, silicon oxides (SiOₓ) are used. The Si-composite can also be an alloy of Si with inert metals or non-metals. Other examples of Si-composite materials suitable for use in the embodiments described herein are graphene-silicon composites, graphene oxide-silicon-carbon nanotubes, silicon-polypyroles, and composites of nano and micron sized silicon particles. As described previously, any combination of Si-composite materials can be used in the anode material, or just a single Si-composite material can be used.

In an embodiment, there is provided an anode for an electrochemical energy storage device including silicon particles; a polymer; and a method for producing the silicon-polymer composite anode; wherein the silicon morphologies include, but are not limited to nanorods, nanospheres, nanowires, as well as other types of nano and micron-sized silicon particles. Carbonaceous materials such as graphite, hard carbon, tin, and germanium particles are additional non-exhaustive exemplary anode active materials that can be used in addition to silicon particles. Other conductive additives such as carbon nanotubes and carbon black can be to enhance the conductivity of the coatings; and acids such as citric acid, oxalic acid, and 1,2,3,4-butanetetracarboxylic acid can be used to improve the adhesion to the copper current collector.

In an embodiment, there is provided an anode for an electrochemical energy storage device including silicon particles; a polymer; and a method for producing the silicon-polymer composite anode; wherein the silicon, polymer and other anode active materials are dispersed using a suitable solvent used at any suitable amount. In some embodiments, the solvent is N,N-dimethylformamide. Other solvents include but are not limited to N-methyl-2-pyrrolidone (NMP), dimethyl sulfone (DMSO₂), dimethyl sulfoxide (DMSO), N—N-dimethyl acetamide (DMAc), ethylene carbonate (EC), and propylene carbonate (PC).

In an embodiment, there is provided an anode for an electrochemical energy storage device including silicon particles; a polymer; and a method for producing the silicon-polymer composite anode; wherein the silicon, polymer and other materials are mixed together to form a mixture, followed by adding a solvent to the mixture and coating the mixture on a copper current collector, and a removing the solvent form the coating and subjecting the coated current collector to a heat treatment.

In another embodiment, there is provided an anode for an electrochemical energy storage device, wherein stabilization of PAN forms ladder polymer compounds by cyclization due to heating in an inert atmosphere from about 200 to 600° C., such as in the range of from 240 to 450° C. This is confirmed using Fourier transform infrared (FT-IR) spectroscopy to analyze the conversion of C≡N to C═N. Upon heat treatment, PAN forms elastic but robust films to allow for controlled fragmentation/pulverization of silicon particles within the binder matrix.

In an embodiment, there is provided an anode for an electrochemical energy storage device including silicon particles; a polymer; and a method for producing the silicon-polymer composite anode; wherein the solids in the slurry contain from 10 to 80 wt. % of silicon with from 10 to 60 wt. % of carbonaceous materials, and from 10 to 40 wt. % of PAN polymer. Exemplary silicon-polymer anodes can include 48:32:18 Silicon:Carbonaceous material:PAN by weight.

Conductive additives can be added at low loadings of from 0.1 to 5 wt. %, and from 0.01 to 1 wt. % of acids can be added to the slurry. Any suitable conductive nanoparticles can be used, including, but not limited to, VGCF, carbon black, and carbon nanotubes. The addition of such conductive additive nanoparticles can enhance the conductivity of the anode material. Acid binders that may be included in the anode slurry used to make the anode material can include, for example, oxalic acid, citric acid, maleic acid, tartaric acid, and 1,2,3,4-butanetetracarboxylic acid. Acid binders can be used to improve dispersion and adhesion properties. When used in the anode material, the acid binder may be present in a range from about 0.01 to about 2 wt. %.

In some embodiments, the slurry includes from about 30 to 60 wt. % of solids and from about 70 to 40 wt. % solvent. The slurry has a viscosity ranging between from 3000 to 6000 centipoise (cP) at spindle rotation speeds of from 20 to 100 rpm, with 800 to 1000 cP variance for a given slurry.

In an aspect of the disclosure, the electrochemical energy storage device electrolyte includes a) dual-salt electrolyte; b) an aprotic organic solvent system; c) and at least one additive.

In another aspect of the disclosure, the electrochemical energy storage device electrolyte includes a) dual-salt electrolyte; b) an aprotic organic solvent system; c) and at least one additive; wherein the dual-salt contains the lithium salts LiPF₆ and LiFSI present in the range of from 10 to 30 wt. %.

A variety of lithium salts may be used in the dual-salt electrolyte, including, for example, Li(AsF₆); Li(PF₆); Li(CF₃CO₂); Li(C₂F₅CO₂); Li(CF₃SO₃); Li[N(CP₃SO₂)₂]; Li[C(CF₃SO₂)₃]; Li[N(SO₂C₂F₅)₂]; Li(ClO₄); Li(BF₄); Li(PO₂F₂); Li[PF₂(C₂O₄)₂]; Li[PF₄C₂O₄]; lithium alkyl fluorophosphates; Li[B(C₂O₄)₂]; Li[BF₂C₂O₄]; Li₂[B₁₂Z₁₂₋ⱼHⱼ]; Li₂[B₁₀X_{10-j′}H_{j′}]; or a mixture of any two or more thereof, wherein Z is independent at each occurrence a halogen, j is an integer from 0 to 12 and j′ is an integer from 1 to 10.

In another aspect of the disclosure, the electrochemical energy storage device electrolyte includes a) dual-salt electrolyte; b) an aprotic organic solvent system; c) and at least one additive; wherein at least one solvent in the aprotic organic solvent system is a fluorinated cyclic carbonate, such as fluoroethylene carbonate in a range of from 10 to 30 wt. %.

In another aspect of the disclosure, the electrolyte further includes an aprotic organic solvent selected from open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof in a range of from 40 to 90 wt. %.

In another aspect of the disclosure, the at least one additive is a compound containing at least one unsaturated carbon-carbon bond, carboxylic acid anhydrides, sulfur-containing compounds, phosphorus-containing compounds, boron-containing compounds, silicon-containing compounds, nitrogen-containing compounds, or mixtures thereof in a range of from 0.1 to 5 wt. %.

In another aspect of the disclosure, an electrochemical energy storage device is provided that includes a cathode, an anode and an electrolyte as described herein. In one embodiment, the electrochemical energy storage device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical energy storage device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery.

Suitable cathodes include those such as, but not limited to, a lithium metal oxide, spinel, olivine, carbon-coated olivine, LiCoO₂, LiNiO₂, LiMn_{0.5}Ni_{0.5}O₂, LiMn_{0.3}Co_{0.3}Ni_{0.3}O₂, LiMn₂O₄, LiFeO₂, LiNiₓCo_{y}Met_{z}O₂, A_{n′}B₂(XO₄)₃, vanadium oxide, lithium peroxide, sulfur, polysulfide, a lithium carbon monofluoride (also known as LiCFₓ) or mixtures of any two or more thereof, where Met is Al, Mg, Ti, B, Ga, Si, Mn or Co; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, and 0≤z≤0.5 and 0≤n₁≤0.3. According to some embodiments, the spinel is a spinel manganese oxide with the formula of Li_{1+z}Mn_{2-z}Met′″_{y}O₄₋ₘX′ₙ, wherein Met′″ is Al, Mg, Ti, B, Ga, Si, Ni or Co; X′ is S or F; and wherein 0≤x≤0.3, 0≤y≤0.5, 0≤z≤0.5, 0≤m≤0.5 and 0≤n≤0.5. In other embodiments, the olivine has a formula of LiFePO₄, or Li₁₊ₓFe_{1z}Met″_{y}PO₄₋ₘX′ₙ, wherein Met″ is Al, Mg, Ti, B, Ga, Si, Ni, Mn or Co; X is S or F; and wherein 0≤x≤0.3, 0 0≤y≤0.5, 0≤z≤0.5, 0≤m≤0.5 and 0≤n≤0.5.

In an embodiment, a secondary battery is provided including a positive and a negative electrode separated from each other using a porous separator and the electrolyte described herein.

A suitable separator for the lithium battery often is a microporous polymer film. Examples of polymers for forming films include polypropylene, polyethylene, nylon, cellulose, nitrocellulose, polysulfone, polyacrylonitrile, polyvinylidene fluoride, polybutene, or copolymers or blends of any two or more such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

The disclosure will be further illustrated with reference to the following specific examples. It is understood that these examples are given by way of illustration and are not meant to limit the disclosure or the claims to follow.

### Example A—Preparation of Silicon-Polymer Composite Anode

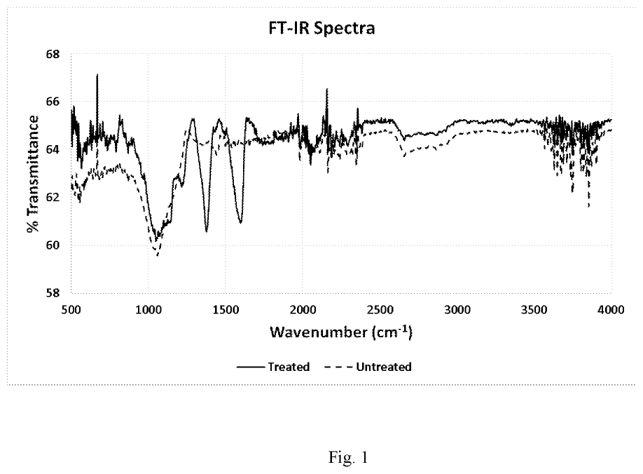

48% silicon powder (1 μm) was used as the active material and mixed with 17.7% PAN by ball milling the solids at low rpm. 32% of graphite was added to the solid mixture and ball milled. 2.2% of conductive carbon black and 0.1% of oxalic acid were dispersed in DMF using high-shear dispersion. The solid mixture is then added to the dispersion and allowed to mix overnight. A benchtop doctor-blade coater was used to coat the slurry on to copper current collectors to achieve electrodes with ˜3 mg/cm² loading. The electrodes were then dried at 60° C. in a convection oven before heat treatment in an inert argon gas atmosphere at 330° C. FIG. 1 shows the FTIR spectra of silicon-polymer composite anodes before and after heat treatment in an inert argon gas atmosphere at 330° C. The peak highlighted by a circle at ˜1600 cm⁻¹ corresponds to C═N and is only present in the sample treated at 330° C., indicating cyclization of PAN.

### Example B—Preparation of Silicon-Polymer Composite Anode

The anode was prepared using the same method as used for Example A with citric acid used in place of oxalic acid.

### Example C—Electrolyte Preparation

Electrolyte formulations were prepared in a dry argon filled glovebox by combining all the electrolyte components in a glass vial and stirring for 24 hours to ensure complete dissolution of the salts. Comparative Example (CE) is a commercially used reference electrolyte and Embodiment Example (EE) is a representative example electrolyte as per the present disclosure. Both electrolytes had different additives added to the base formulation. The electrolyte formulations are summarized in Table A:

TABLE A

| Electrolyte | CE | EE |
|---|---|---|
| LiPF6 | 12.7 | 13.5 |
| LiFSI | 0.0 | 7.1 |
| EMC | 61.1 | 0.0 |
| EC | 26.2 | 0.0 |
| PP | 0.0 | 28.3 |
| EP | 0.0 | 28.0 |
| FEC | 0.0 | 23.1 |
| PC | 0.0 | 0.0 |
| Additives | | |
| VC | 2.0 | 0.0 |
| DPC | 0.0 | 1.0 |
| Pyr 11 TMS PF6 | 0.0 | 1.0 |

Table B below compares the viscosity and conductivity values of CE and EE at room temperature (23±2° C.).

TABLE B

| Electrolyte | Viscosity (cP) | Conductivity (mS) |
|---|---|---|
| CE | 3.3 | 8.4 |
| EE | 4.4 | 8.8 |

### Example D—Cell Fabrication—65 mAh Cells

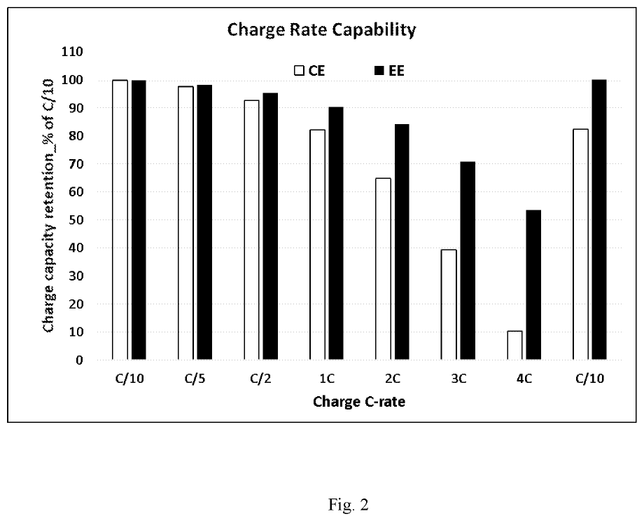

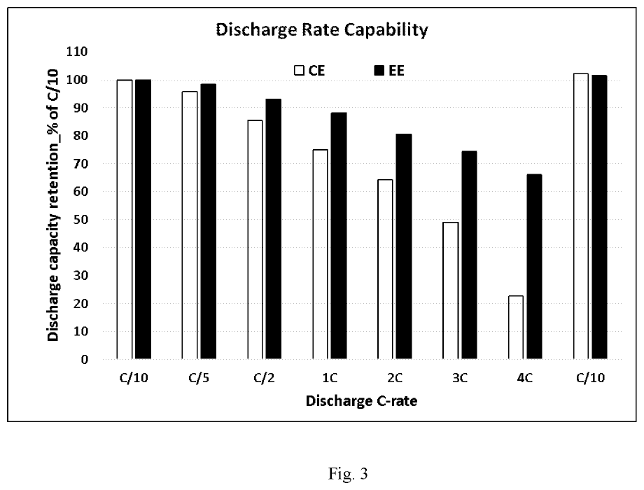

Pouch cells were assembled with NMC811 cathode, and the anode listed in Example A, and electrolytes CE and EE listed in Example C. The NMC811 cathode had ˜4.1 mAh/cm² specific capacity and ˜28 mg/cm² loading. The separator used was polypropylene and the expected cell capacity was ˜65 mAh. The cells were tested in the voltage range of from 4.1 to 3.0 V. FIGS. 2 and 3 the charge and discharge rate capability for the full cells (2 cells with each electrolyte CE and EE) with NMC811 cathode and a silicon-polymer composite anode as per the disclosure. As is evident from the data, the dual salt electrolyte as represented by EE performs better during fast charging and fast discharging compared to CE. This can be attributed to the higher conductivity of EE compared to CE, leading to faster lithium-ion transport.

### Example E—Performance Impacts of Electrolytes

Electrolyte formulations were prepared as described in Example C. Ionic Liquid based electrolytes (IL1 and IL2) and Carbonate Based Electrolytes (Carb1 and Carb2) are compared in effectiveness during both formation and cycling. The electrolyte formulations are summarized in Table C:

| Electrolyte | IL1 | Carbonate1 |
|---|---|---|
| LiPF6 | 24.6 | 13.4 |
| LiFSI | 1.7 | 0 |
| LiPO2F2 | 0 | 1 |
| Pyr13FSI | 38.7 | 0 |
| EC | 0 | 17.1 |
| FEC | 5 | 8.6 |
| DEC | 0 | 29.9 |
| EP | 15 | 15 |
| PP | 15 | 15 |

Additives

| DPC | 1 | 0 |
|---|---|---|
| VC | 0 | 1 |
| MMDS | 0 | 0.5 |
| Electrolyte | IL2 | Carbonate2 |
| LiPF6 | 1.6 | 13.3 |
| LiFSI | 24.1 | 0 |
| LiPO2F2 | 0 | 1 |
| Pyr13FSI | 54.3 | 0 |
| FEC | 20 | 0 |
| EC | 0 | 17.1 |
| FEC | 0 | 8.6 |
| DEC | 0 | 15 |
| EMC | 0 | 15 |
| PP | 0 | 30 |

Additives

| | | |
|---|---|---|
| VC | 0 | 1 |
| Pa Sultone | 0 | 1 |

### Example F—Cell Fabrication—90 mAh Cells

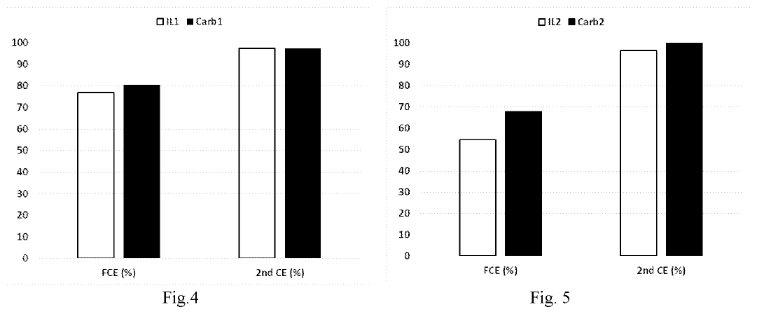

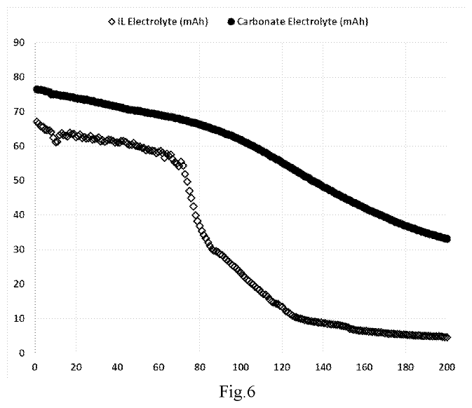

Pouch cells were assembled with NMC811 cathode, and the anode as listed in Example A, and electrolytes IL1, IL2, Carb1 and Carb2 as listed in Example E. The NMC811 cathode had ˜4.16 mAh/cm² specific capacity and ˜21.2 mg/cm² loading. The separator used was polypropylene and the expected cell capacities were ˜90 mAh or ˜180 mAh. The cells were tested in the voltage range of from 4.2 to 2.7 V. FIGS. 4 and 5 the 1^{st} and 2^{nd} cycle efficiency for the full cells with NMC811 cathode and a silicon-polymer composite anode as per the disclosure. FIG. 6 shows the comparison of discharge cycling capacity during a C/3 rate discharge test. As is evident from the data, the carbonate-based electrolytes as represented by Carb1 and Carb2 perform better in 1^{st} cycle efficiency (FCE) compared to CE. This can be attributed to the lower viscosity and resistance in the carbonate-based electrolytes to the Ionic Liquid based ones, leading to faster lithium-ion transport.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed:

1. A method of making an anode for an electrochemical energy storage device, the process comprising:
a) mixing silicon particles and at least one polymer to form a mixture;
b) coating the mixture onto a copper current collector to form a coated copper current collector; and
c) subjecting the coated copper current collector to a temperature treatment to form the anode.

2. The method of claim 1, wherein subjecting the coated copper current collector to the temperature treatment comprises heating the coated copper current collector in an inert atmosphere to a temperature in the range of from about 200° C. to about 600° C.

3. The method of claim 1, further comprising: after step a) and before step b), adding a solvent to the mixture to disperse the silicon particles and the at least one polymer, the solvent being selected from the group consisting of N,N-dimethylformamide (DMF), N-methyl-2-pyrrolidone (NMP), dimethyl sulfone (DMSO₂), dimethyl sulfoxide (DMSO), N—N-dimethyl acetamide (DMAc), ethylene carbonate (EC), and propylene carbonate (PC).

4. The method of claim 3, further comprising: after step b) and prior to step c), removing the solvent from the mixture coated on the copper current collector.

5. The method of claim 3, wherein step c) removes the solvent from the mixture coated on the copper current collector.

6. The method of claim 1, wherein the silicon particles range in size from about 1 nm to about 100 μm.

7. The method of claim 1, wherein the mixture comprises one or more carbonaceous material.

8. The method of claim 7, wherein the one or more carbonaceous material is chosen from graphite, hard-carbon, tin, and germanium particles mixed with active material silicon particles.

9. The method of claim 1, wherein the mixture comprises from 10 to 80% by weight silicon particles.

10. The method of claim 1, wherein the anode comprises from 10 to 40% by weight of polymer.

11. The method of claim 1, wherein the at least one polymer comprises polyacrylonitrile (PAN).

12. The method of claim 1, wherein the silicon particles comprise silicon composite particles.

13. A dual-salt electrolyte, comprising:
(a) LiPF₆ and LiFSI lithium salts in the range of from 10 to 30 wt. % of the electrolyte;
(b) an aprotic organic solvent system containing fluoroethylene carbonate in the range of from 10 to 30 wt. % of the electrolyte; and
(c) at least one additive.

14. The electrolyte of claim 13, wherein the aprotic organic solvent system comprises an open-chain or cyclic carbonate, carboxylic acid ester, nitrite, ether, sulfone, ketone, lactone, dioxolane, glyme, crown ether, siloxane, phosphoric acid ester, phosphite, mono- or polyphosphazene or mixtures thereof.

15. The electrolyte of claim 13, wherein the aprotic organic solvent system is present in a concentration of from 40 to 90 wt. % of the electrolyte.

16. The electrolyte of claim 13, wherein the at least one additive is a compound containing at least one unsaturated carbon-carbon bond, carboxylic acid anhydrides, sulfur-containing compounds, phosphorus-containing compounds, boron-containing compounds, silicon-containing compounds, nitrogen-containing compounds, or mixtures thereof.

17. The electrolyte of claim 13, wherein the at least one additive is present in a concentration of from 0.1 to 5 wt. % of the electrolyte.

18. An anode comprising:
a current collector coated with a plurality of active material particles, wherein each of the plurality of active material particles has a particle size of between about 1 nm and about 100 μm, and at least one polymer, wherein the plurality of active material particles is enclosed by the at least one polymer.

19. An electrochemical energy storage device comprising:
an anode comprising: a plurality of active material particles, wherein each of the plurality of active material particles has a particle size of between about 1 nm and about 100 μm, and at least one polymer, wherein the plurality of active material particles is enclosed by the at least one polymer;
a cathode; and
a dual-salt electrolyte comprising: LiPF₆ and LiFSI lithium salts, an aprotic organic solvent system containing at least one solvent comprising fluoroethylene carbonate, and at least one additive.

20. The electrochemical energy storage device of claim 19, wherein the plurality of active material particles are silicon particles.

21. The electrochemical energy storage device of claim 19, wherein the anode comprises one or more of graphite, hard-carbon, tin, and germanium particles mixed with the plurality of active material particles.

22. The electrochemical energy storage device of claim 19, wherein the at least one polymer comprises polyacrylonitrile (PAN).

23. The electrochemical energy storage device of claim 19, wherein the LiPF₆ and LiF SI lithium salts are present in the range of from 10 to 30 wt. % of the electrolyte and the fluoroethylene carbonate is present in the range of from 10 to 30 wt. % of the electrolyte.

24. The electrochemical energy storage device of claim 19, wherein the cathode comprises a lithium metal oxide, spinel, olivine, carbon-coated olivine, vanadium oxide, lithium peroxide, sulfur, polysulfide, a lithium carbon monofluoride or mixture thereof.

25. The electrochemical energy storage device of claim 19, wherein the cathode is a transition metal oxide material and comprises an over-lithiated oxide material.

26. The electrochemical energy storage device of claim 19, further comprising a porous separator separating the anode and cathode from each other.
